(19) United States
(12) Patent Application Publication
(10) Pub. No.: US 2003/0154363 A1
(43) Pub. Date: Aug. 14, 2003

(54) Stacked register aliasing in data hazard detection to reduce circuit

(76) Inventors: Donald C. Soltis JR., Fort Collins, CO (US); Rohit Bhatia, Fort Collins, CO (US); Ronny L. Arnold, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/074,061

(22) Filed: Feb. 11, 2002

(51) Int. Cl. G06F 9/30

(52) U.S. Cl. 712/217

(57) ABSTRACT

The invention recasts the virtual register file frame calls to alias hazard detection in the hazard detect logic of the physical register file. By way of example, mapping to the stacked registers may be aliased with three sets of 32 registers rows, from 32 to 127, for data hazard calculations to decrease size implementation with minor performance decrease. The invention sacrifices occasional hazard detections—resulting in occasional pipeline stalls as a loss of processor performance—in order to remove the row-by-row dependencies on physical register size. The invention thus reduces the logic requirements associated with the “height” and “width” of the register file: “height” corresponds to the number of registers (e.g., 128), and “width” corresponds to the pipeline stages. The physical register size of the invention is effectively greater than what may be accessed by software at any time; there is no longer a one-to-one correspondence between the virtual and physical register files. In addition, there is no longer a one-to-one correspondence between physical registers and register identifiers for data hazard purposes. Accordingly, more physical registers may be added without a corresponding increase in the hazard detect and bypass logic. If a data hazard exists, an occasional pipeline stall may occur that would not have occurred by incorporating a one-to-one mapping between the register identifiers and physical register files. The physical and decode logic is simplified for the multiple rows of the register file, thereby reducing physical size and power requirements for the EPIC processor.

### BACKGROUND OF THE INVENTION

Explicitly parallel instruction computing (EPIC) processors incorporate bypassing techniques to avoid data hazards within pipelined execution units. To facilitate bypassing, instructions are processed as producers and consumers. An instruction is a “producer” when that instruction generates bypass data. An instruction is a “consumer” when that instruction utilizes the bypass data. A bypass is completed when a register ID (e.g., a 7-bit identifier) matches for both the producer and consumer. As each superscalar EPIC processor has many pipelines, the process of comparing or matching register IDs of producers to consumers is complex: the process is a function of the number of consumers, the number of producers, the number of in-flight instructions (i.e., the pipeline stages from register read to register write), and the number of registers. Accordingly, the data paths and accompanying logic are the subject of many different competing processors in the marketplace. These comparisons occur for up to 128 register IDs, one for each row of the register file. Moreover, in making comparisons, certain latencies are introduced, thereby slowing instruction throughput. There is the need to quickly and efficiently detect data hazards.

Not all data hazards are avoided by bypassing. In the event a bypass cannot occur, the younger consumers and producers stall in the pipeline waiting for producers and consumers to be available. There is also the need to more efficiently determine whether a data hazard exists, or not, in a pipeline in order to offset decreasing operational frequency, increased power dissipation and/or increased circuit area that stem from increasing data hazard detection complexities.

FIG. 1 shows a prior art EPIC architecture 10 utilizing a virtual register rename 12 to map subroutine parameter and local storage registers to physical registers of a register file 14. Register file 14 is shown with registers GR(0)-GR(127), for a 128-register file. Architecture 10 illustratively shows an execution unit 16 with a plurality of pipelines 18(1)-18(N). As known in the art, each pipeline 18 processes instructions within individual stages of the pipeline, such as the fetch stage F, the register read stage R, the execute stage E, the detect exception stage D, and the write-back stage W. Within architecture 10, register file 14 is typically written to at the write-back stage W. Bypassing may occur from and between pipelines 18 through bypass logic 20, as shown.

Architecture 10 avoids the unnecessary spilling and filling of registers at subroutine parameter and local storage register procedures through compiler-controlled renaming, via a virtual register rename 12. Virtual register rename 12 has a like number of “virtual” registers VR(0)-VR(127) to map data to frames of physical registers GR(0)-GR(127). More particularly, register file 14 is divided into static and stacked register subsets. The static subset is visible to all procedures and consists of the 32 registers from GR(0) through GR(31) (“static” registers). The stacked subset is local to each procedure and may vary in size from zero to 96 registers beginning at VR(32) (“stacked” registers). The register stack mechanism is implemented by renaming register addresses as a side-effect of subroutine parameter and local storage register procedures. The implementation of this rename mechanism is not otherwise visible to application programs.

FIG. 1 also shows a register ID file 15 with a plurality of register IDs RID(0)-RID(127) for each of virtual and physical registers VR( ), GR( ). Register ID file 15 is used for data hazard detection associated with data producers and consumers within pipelines 18. Data hazard detect logic 17 makes comparisons for each row (0)-(127) of Register ID 15 in order to detect the data hazards.

As shown in FIG. 2, stacked registers are made available to a program by allocating a register stack frame consisting of a programmable number of local and output registers. Essentially, register stack frames from virtual register rename 12 are mapped onto a set of physical registers that operate as a circular buffer containing the most recently created frames. FIG. 2 shows for example the allocation of three frames 26(1), 26(2), 26(3) in virtual register rename 12, and their corresponding general register frames 28(1), 28(2), 28(3) in register file 14, due to three separate call routines. Each call to virtual register rename 12 is made to VR(32) as if all stacked register calls started at the same frame; however mapping to physical register file 14 is made automatically, to the next available physical registers, and starting for example at registers 33(1), 33(2), 33(3) of frames 28(1), 28(2), 28(3). Frames 26 are illustratively mapped to register file frames 28 by mapping lines 30. Ancestor call routines are illustratively shown as frame 31, mapping to general register file frame 34. The first physical register that may be allocated in this way is GR 32, the first stacked register of file 14. Frames 26(1)-26(3) may for example include all of the virtual registers from 32 to 127, starting at VR(32) and mapping to frames 28 within GR(32)-GR (127) of register file 14. In operation, therefore, architecture 10 does not actually consider virtual register rename 12 in making a call, but rather processes each routine as if all registers GR (32)-GR(127) are available. A frame may include a rotation from GR(127) to GR(32); that is register file 14 is a circular buffer.

Nevertheless, a memory store operation may occur if an attempt is made to over-write “in use” data of a particular register GR(32)-GR(127). As memory store operations are relatively slow, compared to register file operations, this is extremely undesirable; there is therefore a tendency for EPIC designers to increase the physical register size to mitigate this problem. However, any register file expansion complicates the data hazard detection logic 15, 17 of architecture 10.

In addition, the design of FIG. 1 and FIG. 2 provides for detection of all possible conflicts or data hazards within rows of register file 14. That is, frames 26, 28 are allocated on the basis of the “expected” memory space needed for procedure parameters and local storage registers. Nevertheless, the memory space allocation required is generally smaller than the full set of physical registers and the likelihood of an actual conflict is also small. Accordingly, architecture 10 incorporates extensive logic 15, 17 to accommodate all possible conflicts, from mapping frames 26 to 28, and consequently underutilizes much of the data hazard detection logic 17 between the GR registers of file 14.

The invention seeks to advance the state of the art in processing architectures by providing methods and systems for detecting data hazards with the register file, to reduce the data hazard detection logic of the prior art. One feature of the invention is to provide a superscalar EPIC processor with efficient mapping between the virtual register file and the actual register file. Several other features of the invention are apparent within the description that follows.

### SUMMARY OF THE INVENTION

The following patents provide useful background to the invention and are incorporated herein by reference: U.S. Pat. No. 6,188,633; U.S. Pat. No. 6,105,123; U.S. Pat. No. 5,857,104; U.S. Pat. No. 5,809,275; U.S. Pat. No. 5,778,219; U.S. Pat. No. 5,761,490; U.S. Pat. No. 5,721,865; and U.S. Pat. No. 5,513,363.

The invention of one aspect simplifies the logic associated with producer-to-producer and producer-to-consumer data hazards so that a virtual register file may map frames of data to a physical register file of equal or larger size but without corresponding growth of data hazard detect logic. By way of example, the invention of one aspect recasts the virtual register file frame calls to alias hazard detection in the hazard detect circuitry of the physical register file. By way of example, mapping to the stacked registers may be aliased with three sets of 32 registers rows, from 32 to 127, for data hazard calculations to decrease size implementation with minor performance decrease. That is, the invention sacrifices occasional false hazard detections—resulting in occasional pipeline stalls as a loss of processor performance—in order to remove the row-by-row dependencies on physical register size. The invention thus reduces the logic requirements associated with the “height” of the register file: “height” corresponds to the number of registers (e.g., 128), while “width” corresponds to the pipeline stages.

Accordingly, the invention invokes the following precepts:

The physical register size of the invention is effectively greater than what may be allocated and therefore accessible by software at any time; since there is no longer a one-to-one correspondence between the stacked physical registers and their representation in the hazard detection logic, more physical registers may be added without a corresponding increase in the hazard detect logic

If a false data hazard exists, an occasional pipeline stall may occur, with the invention, that would not have occurred in the prior art incorporating a one-to-one mapping between the physical stacked registers and hazard detect stacked register identifiers

The physical decode logic is simplified for the multiple rows of the data hazard detect logic, as compared to the prior art, thereby reducing physical size and power requirements for the EPIC processor

The invention is next described further in connection with preferred embodiments, and it will become apparent that various additions, subtractions, and modifications can be made by those skilled in the art without departing from the scope of the invention.

### BRIEF DESCRIPTION OF THE DRAWINGS

A more complete understanding of the invention may be obtained by reference to the drawings, in which:

FIG. 1 schematically illustrates an EPIC architecture of the prior art utilizing mapping between virtual and physical registers;

FIG. 2 illustrates the one-to-one mapping between the virtual register file and physical register file of the architecture of FIG. 1;

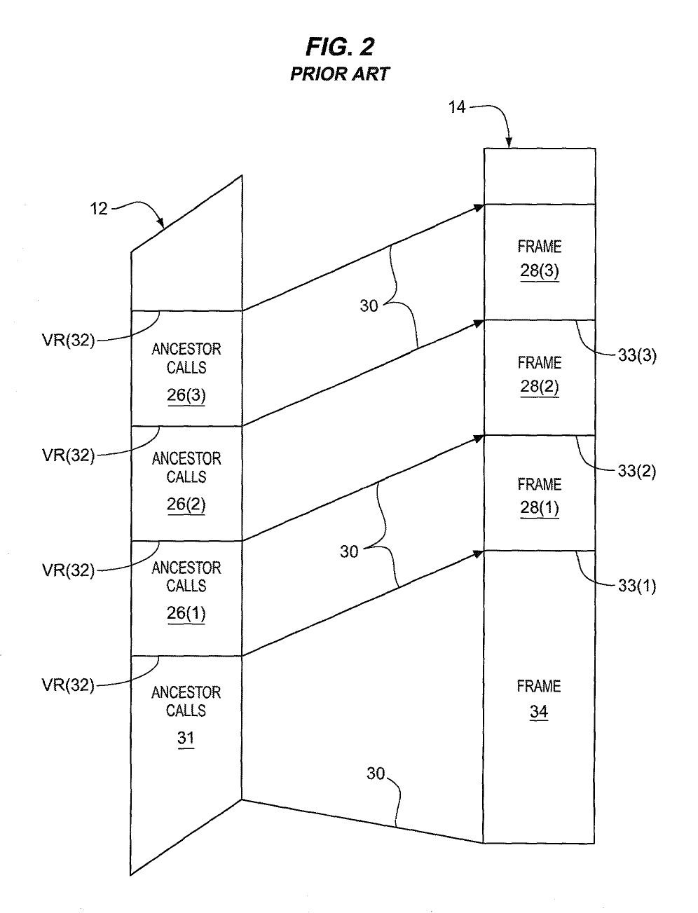

FIG. 3 schematically illustrates a processing unit of the invention for processing instructions through pipeline units with hazard detect logic aliasing with the register file; and

FIG. 4 illustrates aliased mapping between the physical register file and hazard detect register identifiers of the architecture of FIG. 3.

### DETAILED DESCRIPTION OF THE DRAWINGS

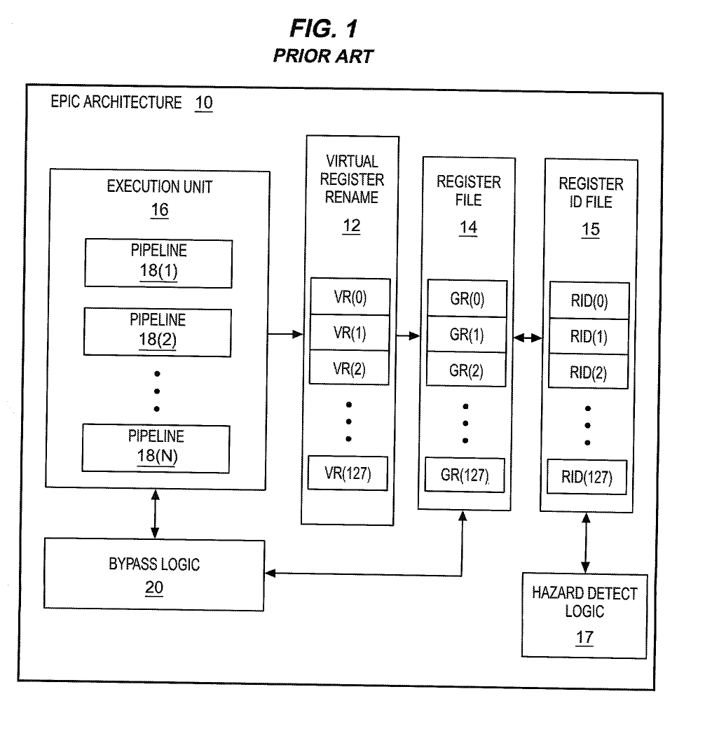

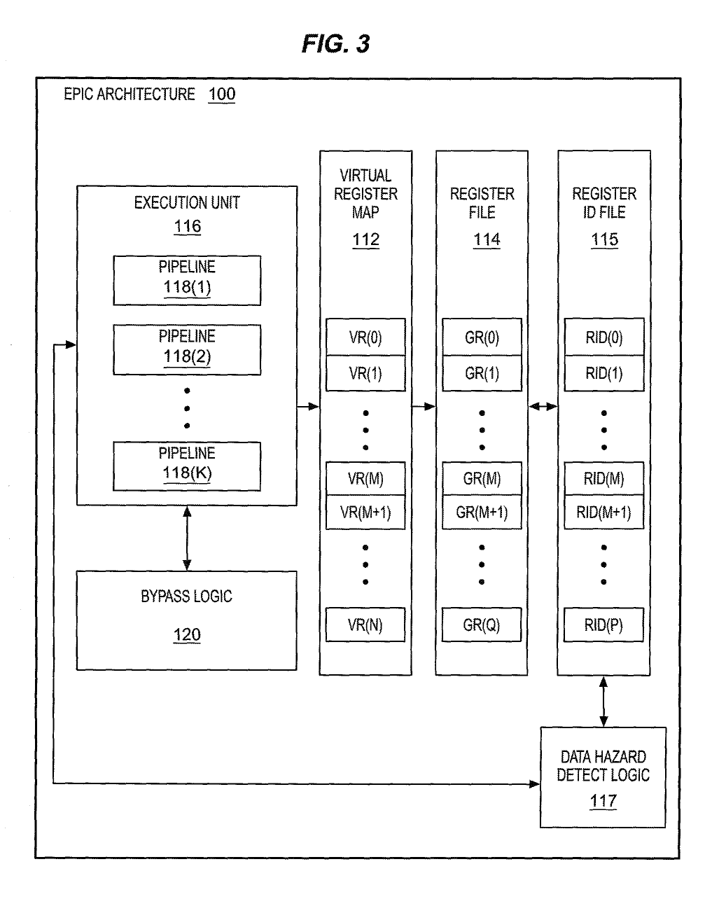

FIG. 3 shows an EPIC architecture 110 utilizing a virtual register map 112 to map subroutine parameters and local storage registers via subroutine calls, allocation and returns to physical registers GR(0)GR(Q) of a register file 114. A register ID file 115 has a plurality of register IDs (RID(0)-RID(P)) used for data hazard detection, in conjunction with data hazard detect logic 117. Architecture 110 illustratively shows an execution unit 116 with a plurality of pipelines 118(1)-118(K). Each pipeline 118 processes instructions within individual stages, e.g., stages F,R,E,D and W stages discussed in connection with FIG. 1. Bypassing may occur from and between pipelines 118 through bypass logic 120, as shown.

As above, architecture 110 avoids the unnecessary spilling and filling of registers at procedure call and return interfaces through compiler-controlled renaming using register files 112, 114. Register file 114 is also preferably divided into static and stacked register subsets. The static subset is visible to all procedures and consists of registers GR(0) through GR(M) (“static” registers). The stacked subset is local to each procedure and may vary in size from zero to (Q-(M+1)) registers, beginning at stacked register GR(M+1).

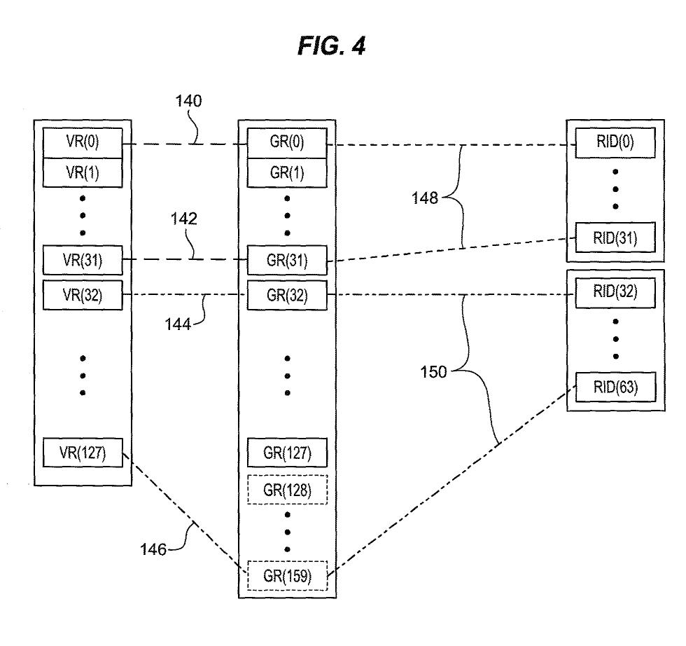

Virtual registers VR(0)-VR(M) of file 112 are preferably one-to-one with the static GR registers GR(0)-GR(M) of file 114; however, unlike FIG. 1, virtual registers VR(M+1)-VR(N) are not necessarily one-to-one with stacked registers GR(M+1)-GR(Q) of file 114 (i.e., N may not equal Q). In addition, register ID file 115, RID(0)-RID(P), is not one-to-one with register file 114. That is, Q>P; accordingly, architecture 110 aliases certain hazard detects within register file rows GR(M+1)-GR(Q). FIG. 4 illustrates an example of how this aliasing occurs.

In FIG. 4, a virtual register map 112 has 128 virtual registers VR(0)-VR(127) used to map frames of data to register file 114, with 160 registers GR(0)-GR(159), the stacked registers being GR(M+1)-GR(Q)=GR(32)-GR(159). Specifically, virtual registers VR(0)-VR(31) map one-to-one with static registers GR(0)-GR(31), between mapping lines 140, 142. Virtual registers VR(32)-VR(127) map to frames of physical registers starting anywhere GR(32)-GR(159) between mapping lines 144, 146. At the same time, hazard detect through register ID file 115 aliases physical registers GR(32)-GR(159) in hazard detect capability. More particularly, hazard detection logic 117 detects data hazards for multiple register IDs corresponding to multiple rows of register file 114; hazard detection is thus not unique for each row. If for example the register ID file has 32 register identifiers, then each subsequent set of 32 GRs beginning with GR(32) (e.g., GR(32:63), GR(65:95). GR(96:127) and GR(128:159)) alias respectively to the same 32 hazard detect register identifiers RID(32:63), as illustrated in FIG. 4. Specifically, in this example, register IDs now alias to common hazard detect logic for rows GR(32), GR(64), GR(96), for rows GR(33), GR(65), GR(97), and so on, of register file 114. Mapping lines 148 illustrate that RID(0:31) maps to GR(0:31). RID(32:63) maps to each set GR(32:63), GR(64:95), GR(96:127), GR(128:159) illustratively by mapping lines 150.

Those skilled in the art should appreciate that the windowing of FIG. 4 is made for illustrative purposes; that is, windows with fewer or more than 32 registers may be selected. The number 32 nevertheless works well in repetition for a 128-register file.

The invention thus provides for expansion of the physical register file without the accompanying increase of hazard detect logic. By way of example, register file 114 grew beyond GR(127) of FIG. 1 but without a corresponding growth of hazard detect logic for each register identifier of register ID file 115.

Since certain changes may be made in the above figures, description, methods and systems without departing from the scope of the invention, it is intended that all matter contained in the above description or shown in the accompanying drawing be interpreted as illustrative and not in a limiting sense. It is also to be understood that the following claims are to cover all generic and specific features of the invention described herein, and all statements of the scope of the invention which, as a matter of language, might be said to fall there between.

What is claimed is:

1. A method for stacked register aliasing in data hazard detection of a processor, comprising the steps of:
calling for a first group of registers within a register file of the processor;
detecting data hazards, if any, associated with first register identifiers of the first group;
calling for a second group of registers within the register file; and
detecting data hazards, if any, associated with second register identifiers of the second group, wherein the first and second register identifiers overlap in hazard detect logic across two or more rows of the register file.

2. A method of claim 1, the steps of calling comprising calling for a group within a 128-register register file.

3. A method of claim 2, the steps of mapping comprising detecting comprises utilizing groups of 32 register identifiers to alias data hazard detect logic to windows of 32-register frames

4. A processor for processing program instructions, comprising:
a register file;
an execution unit having an array of pipelines for processing the instructions and for writing bypass data to the register file; and
data hazard detect logic for detecting and aliasing data hazard detection for two or more rows of the register file

5. A system of claim 4, further comprising a register ID file for facilitating data hazard detection associated with rows of the register file, the register ID file having a plurality of register identifiers, the data hazard detect logic aliasing data hazard detection according to mapping of the register identifiers.

6. A system of claim 5, the register ID file mapping sequential 32-registers with the common hazard logic to more than 32 stacked registers of the register file to alias in 32-register sequences.

7. In data hazard detect logic of a processor of the type having a register file and a register ID file providing row-to-row data hazard detection, the improvement wherein the register file ID aliases row-to-row hazard detection of the register file by common data hazard detection logic for two or more rows of the register file.
